(19) United States
(12) Patent Application Publication
(10) Pub. No.: US 2019/0128603 A1
(43) Pub. Date: May 2, 2019

(54) Vapor Stripping by Desublimation and Dissolution

(71) Applicants: Larry Baxter, Orem, UT (US); Kyler Stitt, Lindon, UT (US); Blake Pilling, Provo, UT (US); Nathan Davis, Bountiful, UT (US)

(72) Inventors: Larry Baxter, Orem, UT (US); Kyler Stitt, Lindon, UT (US); Blake Pilling, Provo, UT (US); Nathan Davis, Bountiful, UT (US)

(21) Appl. No.: 15/796,085

(22) Filed: Oct. 27, 2017

(51) Int. Cl. F25J 3/06; F25J 3/08; B01D 53/00; B01D 7/02

(52) U.S. Cl. CPC F25J 3/0605; F25J 3/063; B01D 7/02; F25J 3/0695; B01D 53/002; F25J 3/08

(57) ABSTRACT

Devices, methods, and systems for stripping a vapor from a gas are disclosed. A carrier gas is bubbled through a liquid coolant in a vessel. The vessel contains a mesh screen, packing materials, or combinations thereof. The carrier gas has a vapor component. The vapor component condenses, freezes, deposits, desublimates, or a combination thereof out of the carrier gas onto the mesh screen, the packing material, or combinations thereof, as a solid component. The solid component dissolves into the coolant as the coolant passes through the mesh screen, the packing material, or combinations thereof.

### GOVERNMENT INTEREST STATEMENT

This invention was made with government support under DE-FE0028697 awarded by the Department of Energy. The government has certain rights in the invention.

### FIELD OF THE INVENTION

The devices, systems, and methods described herein relate generally to gas/vapor separations. More particularly, the devices, systems, and methods described herein relate to removing vapors from gases in cryogenic conditions.

### BACKGROUND

Stripping gases from vapors is a process done in many industries. Direct-contact heat and material exchangers are a commonly used option. However, when solids form directly from the gas, solids can form, fouling the exchangers. A stripping process where fouling is mitigated would be beneficial.

### SUMMARY

Devices, methods, and systems for stripping a vapor from a gas are disclosed. A carrier gas is bubbled through a liquid coolant in a vessel. The vessel contains a mesh screen, packing materials, or combinations thereof. The carrier gas has a vapor component. The vapor component condenses, freezes, deposits, desublimates, or a combination thereof out of the carrier gas onto the mesh screen, the packing material, or combinations thereof, as a solid component. The solid component dissolves into the coolant as the coolant passes through the mesh screen, the packing material, or combinations thereof.

The liquid coolant may consist of water, hydrocarbons, liquid ammonia, liquid carbon dioxide, cryogenic liquids, or combinations thereof. The hydrocarbons may consist of 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methyl cyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

The liquid coolant may consist of a mixture of a solvent and either an ionic compound or soluble organic compound. The ionic compounds may consist of potassium carbonate, potassium formate, potassium acetate, calcium magnesium acetate, magnesium chloride, sodium chloride, lithium chloride, and calcium chloride. The soluble organic compounds may consist of glycerol, ammonia, propylene glycol, ethylene glycol, ethanol, and methanol. The solvent may be water, hydrocarbons, liquid ammonia, liquid carbon dioxide, cryogenic liquids, or combinations thereof.

The carrier gas may consist of flue gas, syngas, producer gas, natural gas, steam reforming gas, hydrocarbons, light gases, refinery off-gases, organic solvents, steam, ammonia, or combinations thereof.

The vapor may consist of carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

The mesh screen, the packing materials, or a combination thereof, may be made of stainless steel, carbon steel, galvanized steel, brass, aluminum, copper, ceramics, plastic polymers, or a combination thereof. The mesh screen, the packing materials, or a combination thereof, may have a coating comprising ceramics, polytetrafluoroethylene, polychlorotrifluoroethylene, natural diamond, man-made diamond, chemical-vapor deposition diamond, polycrystalline diamond, or combinations thereof.

The vessel may be a direct-contact exchanger. The direct-contact exchanger may be a bubble contactor, a distillation column, a packed tower, an air-sparged hydrocyclone, a nozzle-injected hydrocyclone, a spray tower, or a drip tower. A gas outlet of the direct-contact exchanger may be equipped with a mist eliminator.

Passing the carrier gas into the vessel may involve bubbling the carrier gas through a bubble plate, a bubble tray, a sparger, or a combination thereof. Passing the carrier gas into the vessel may involve injecting the carrier gas into the vessel below a liquid inlet and passing the liquid coolant into the vessel through the liquid inlet, the inlet being a nozzle, a sprayer, a drip tray, or a combination thereof.

The mesh screen may be vibrated such that the solid component breaks off of the mesh screen.

Large bubbles of the carrier gas may be broken up into small bubbles as the large bubbles pass through the mesh screen.

The liquid coolant may consist of an entrained solid. The entrained solid may be soot, dust, minerals, microbes, solid carbon dioxide, solid nitrogen oxide, solid sulfur dioxide, solid nitrogen dioxide, solid sulfur trioxide, solid hydrogen sulfide, solid hydrogen cyanide, ice, solid hydrocarbons, precipitated salts, or combinations thereof.

The vessel may contain an indirect-contact heat exchanger. The indirect-contact heat exchanger may further cool the liquid coolant. The indirect-contact heat exchanger may provide a surface on which the solid component forms and from which the solid component is dissolved into the liquid coolant. The indirect-contact heat exchanger may be vibrated such that the solid component breaks off of the indirect-contact heat exchanger.

### BRIEF DESCRIPTION OF THE DRAWINGS

In order that the advantages of the described devices, systems, and methods will be readily understood, a more particular description of the described devices, systems, and methods briefly described above will be rendered by reference to specific embodiments illustrated in the appended drawings. Understanding that these drawings depict only typical embodiments of the described devices, systems, and methods and are not therefore to be considered limiting of its scope, the devices, systems, and methods will be described and explained with additional specificity and detail through use of the accompanying drawings, in which:

FIGS. 1A-B show cross-sectional side views of a portion of a mesh screen.

FIG. 2 shows a cross-sectional side view of a direct-contact exchanger.

FIG. 3 shows a cross-sectional side view of a direct-contact exchanger.

FIG. 4 shows a cross-sectional side view of a direct-contact exchanger.

FIG. 5 shows an isometric cross-section of a direct-contact exchanger.

FIG. 6 shows an isometric cutaway view of a direct-contact exchanger.

FIG. 7 shows a method for stripping a vapor from a gas.

### DETAILED DESCRIPTION

It will be readily understood that the components of the described devices, systems, and methods, as generally described and illustrated in the Figures herein, could be arranged and designed in a wide variety of different configurations. Thus, the following more detailed description of the embodiments of the described devices, systems, and methods, as represented in the Figures, is not intended to limit the scope of the described devices, systems, and methods, as claimed, but is merely representative of certain examples of presently contemplated embodiments in accordance with the described devices, systems, and methods.

Combustion flue gas consists of the exhaust gas from a fireplace, oven, furnace, boiler, steam generator, or other combustor. The combustion fuel sources include coal, hydrocarbons, and biomass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The devices, systems, and methods disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

Direct-contact exchangers are devices in which at least two constituents (fluid-fluid or fluid-solid) interact directly to exchange heat, material, or both. These may include bubble contactors, distillation columns, packed towers, air-sparged hydrocyclones, nozzle-injected hydrocyclones, or any other device in which two or more components interact directly.

Desublimating direct-contact exchangers, in which a condensable vapor in the gas condenses, freezes, deposits, or desublimates, have unique challenges. One of these is that the vapor tends to form a solid on vessel surfaces, such as inlets, outlets, or interior features, like mesh screens. This leads to blockage, creating further slowing of fluid flows, and increasing solid deposits. A solution to this problem is disclosed herein. When the gas containing the vapor passes through a vessel with mesh screens, the vapor deposits on the mesh screens. The amount of intimate surface area contact between the coolant and the vapor component of the flue gas is minimal, resulting in minimal stripping of the vapor component. Once deposited, the solid vapor component has orders of magnitude more surface area contact with the coolant. By utilizing a coolant in which the solid form of the vapor is soluble, the solids deposited are immediately dissolved. In this manner, the gas is cooled, the vapor is stripped, and the process does not become blocked by solids.

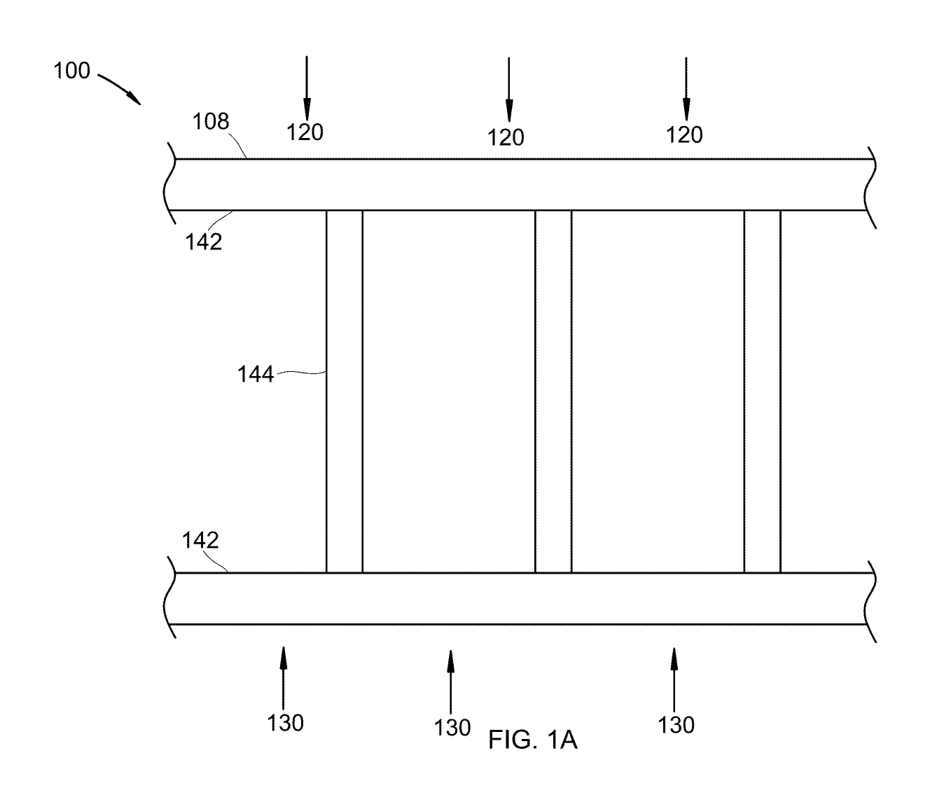

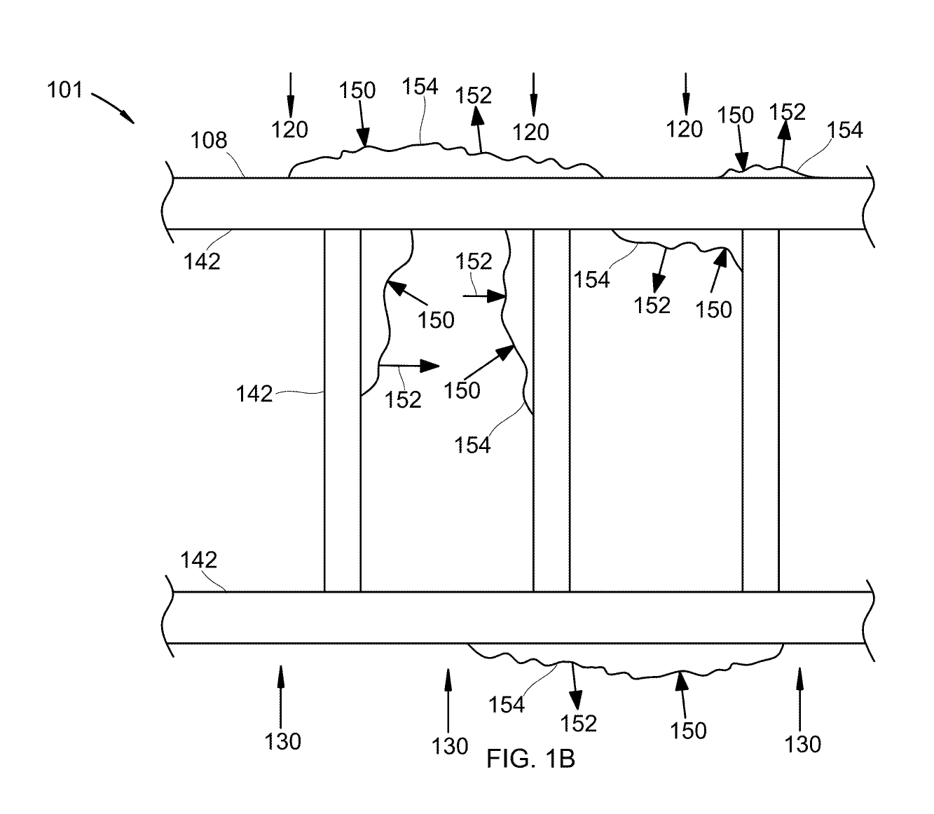

Referring now to the Figures, FIGS. 1A-B show cross-sectional side views 100 and 101 of a portion of a mesh screen 108 that may be used in the described devices, systems, and methods. Mesh screen 108 consists of horizontal members 142 and vertical members 144. Mesh screen 108 is part of a vessel (i.e., direct-contact exchangers). Carrier gas 130 is bubbled upward through liquid coolant 120 in the vessel. Carrier gas 130 comprises a vapor component. This vapor component condenses, freezes, deposits, desublimates, or a combination thereof 150 onto mesh screen 108 as solid component 154. Solid component 154 dissolves 152 into liquid coolant 120, leaving mesh screen 108 clear of solids. The size of solid component 154 on mesh screen 108 is exaggerated for clarity in the figure.

In some embodiments, mesh screen 108 could consist of any typical mesh arrangement, such as crisscrossing mesh, steel wool-style mesh. In some embodiments, liquid coolant 120 could flow co-current or cross-current to carrier gas 130.

In one embodiment, mesh screen 108 is made of stainless steel. Liquid coolant 120 consists of cryogenic isopentane. Carrier gas 130 consists of flue gas, with the vapor components including acid gases, but especially carbon dioxide. As the flue gas bubbles through the isopentane, the flue gas is cooled and carbon dioxide and other acid gases present desublimate out, depositing on mesh screen 108. Carbon dioxide and other acid gases are soluble in isopentane, and therefore are dissolved from the solid state into the isopentane.

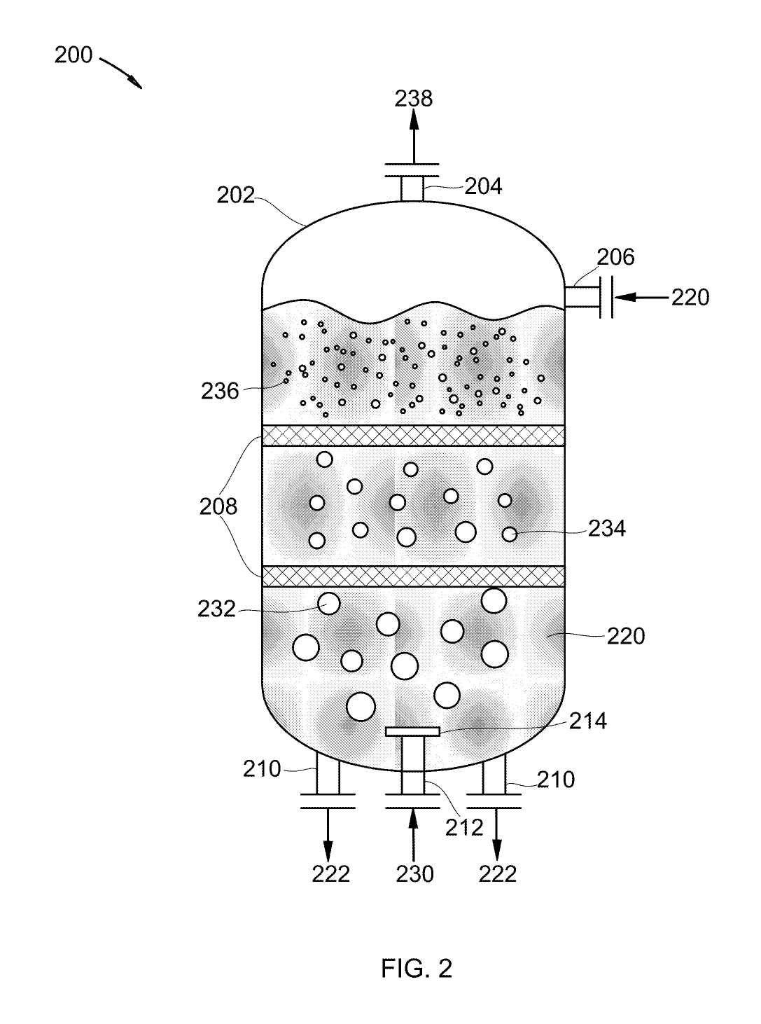

Referring now to FIG. 2, FIG. 2 shows a cross-sectional side view 200 of a direct-contact exchanger 202 that may be used in the described devices, systems, and methods. Exchanger 202, a bubble contactor, consists of gas outlet 204, liquid inlet 206, mesh screens 208 (e.g. mesh screen 108), liquid outlets 210, gas inlet 212, and bubbler 214. Carrier gas 230 (e.g., carrier gas 130) passes through gas inlet 212 and is bubbled out of bubbler 214 upward through liquid coolant 220 (e.g., liquid coolant 120) in exchanger 202. Carrier gas 230 comprises a vapor component. This vapor component condenses, freezes, deposits, desublimates, or a combination thereof onto mesh screens 208 as a solid component. The solid component dissolves into liquid coolant 220, leaving mesh screen 208 clear of solids. Component-enriched liquid coolant 222 leaves through liquid outlets 210 while component-depleted carrier gas 238 leaves through gas outlet 204. Mesh screens 208 also cut bubbles up into smaller bubbles, such as large bubbles 232 being cut into medium bubbles 234 and then into small bubbles 236. In some embodiments, the mesh screens could be internally cooled by a refrigerant or a cold fluid. Smaller bubbles are beneficial to heat and material exchange as a large number of small bubbles provides more gas/liquid surface area than a smaller number of large bubbles.

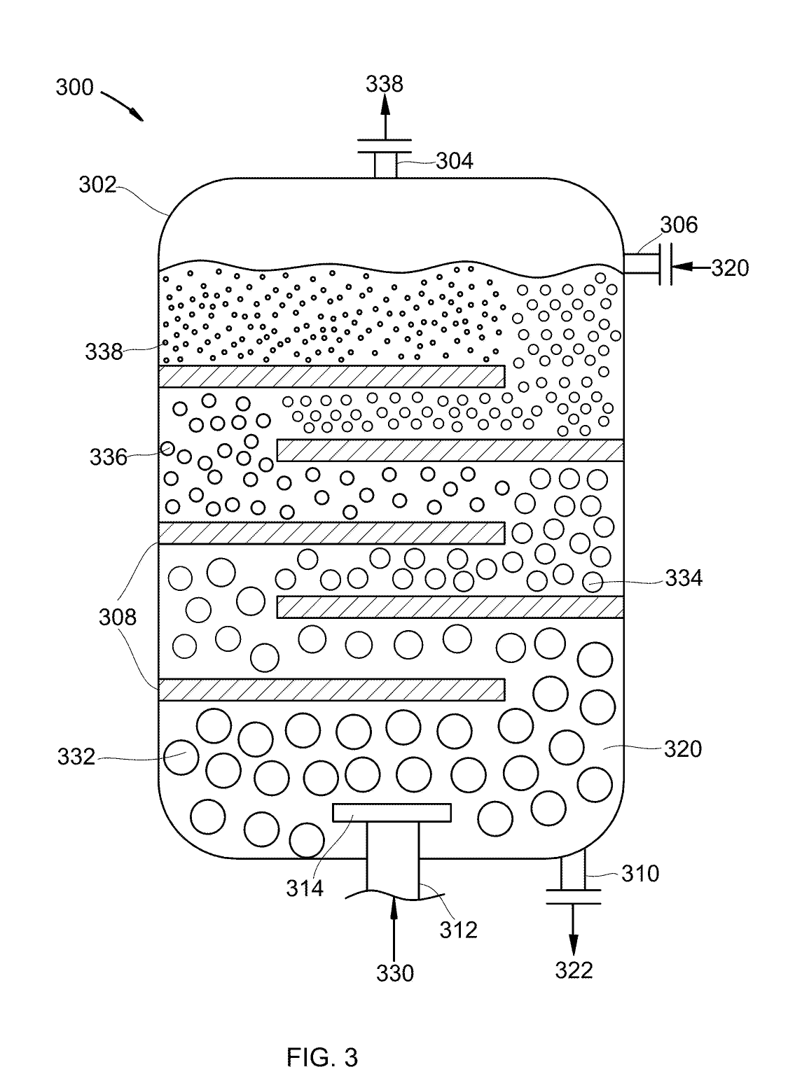

Referring now to FIG. 3, FIG. 3 shows a cross-sectional side view 300 of a direct-contact exchanger 302 that may be used in the described devices, systems, and methods. Exchanger 302, a bubble contactor, consists of gas outlet 304, liquid inlet 306, mesh-screen baffles 308 (e.g. mesh screen 108 and 208), liquid outlets 310, gas inlet 312, and bubbler 314. Carrier gas 330 (e.g., carrier gas 130 and 230) passes through gas inlet 312 and is bubbled out of bubbler 314 upward through liquid coolant 320 (e.g., liquid coolant 120 and 220) in exchanger 302. Carrier gas 330 comprises a vapor component. This vapor component condenses, freezes, deposits, desublimates, or a combination thereof onto mesh-screen baffles 308 as a solid component. The solid component dissolves into liquid coolant 320, leaving mesh screen 308 clear of solids. Component-enriched liquid coolant 322 leaves through liquid outlets 310 while component-depleted carrier gas 338 leaves through gas outlet 304. Mesh-screen baffles 308 also cut bubbles up into smaller bubbles, such as large bubbles 332 being cut into medium bubbles 308 and then into small bubbles 336.

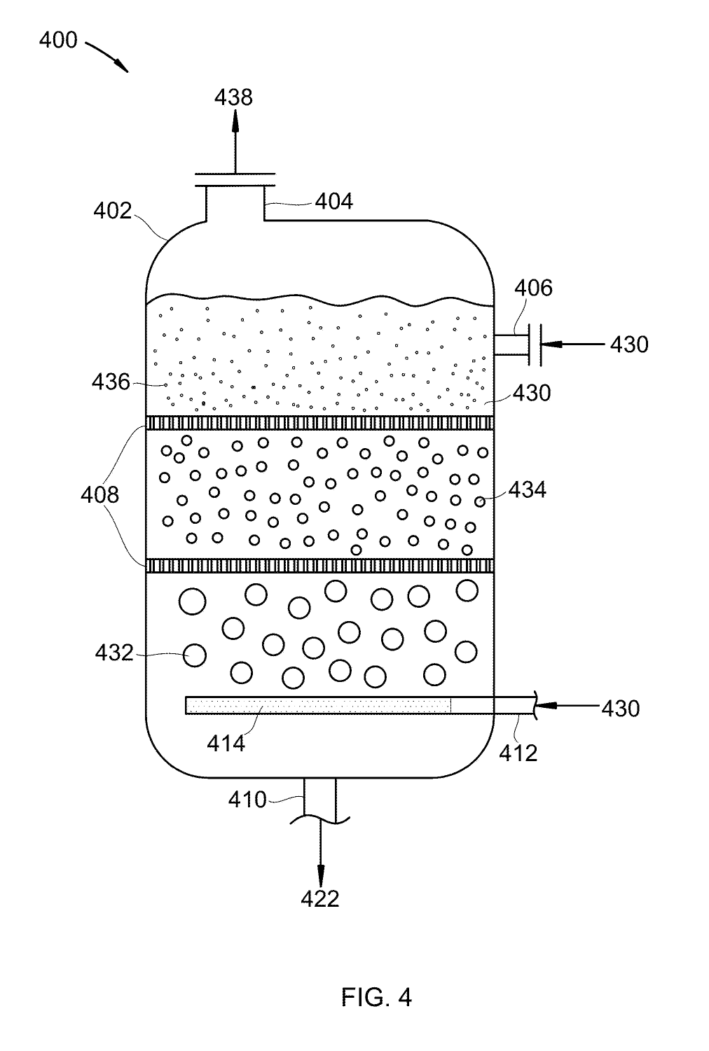

Referring now to FIG. 4, FIG. 4 shows a cross-sectional side view 400 of a direct-contact exchanger 402 that may be used in the described devices, systems, and methods. Exchanger 402, a bubble contactor, consists of gas outlet 404, liquid inlet 406, mesh screens 408 (e.g. mesh screen 108, 208, and 308), liquid outlets 410, gas inlet 412, and sparger 414. Carrier gas 430 (e.g., carrier gas 130, 230, and 330) passes through gas inlet 412 and is bubbled out of sparger 414 upward through liquid coolant 420 (e.g., liquid coolant 120, 220, and 320) in exchanger 402. Carrier gas 430 comprises a vapor component. This vapor component condenses, freezes, deposits, desublimates, or a combination thereof onto mesh screens 408 as a solid component. The solid component dissolves into liquid coolant 420, leaving mesh screen 408 clear of solids. Component-enriched liquid coolant 422 leaves through liquid outlets 410 while component-depleted carrier gas 438 leaves through gas outlet 404. Mesh screens 408 also cut bubbles up into smaller bubbles, such as large bubbles 432 being cut into medium bubbles 408 and then into small bubbles 436.

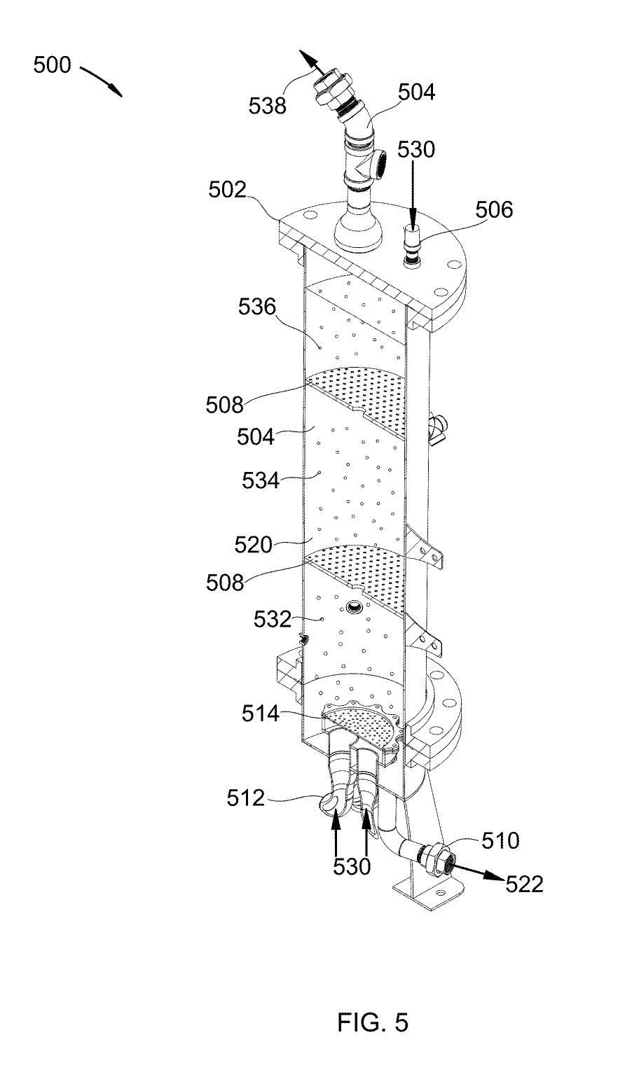

Referring now to FIG. 5, FIG. 5 shows an isometric cross-section 500 of a direct-contact exchanger 502 that may be used in the described devices, systems, and methods. Exchanger 502, a bubble contactor, consists of gas outlet 504, liquid inlet 506, mesh screens 508 (e.g. mesh screen 108, 208, 308, and 408), liquid outlets 510, gas inlet 512, and bubbler 514. Carrier gas 530 (e.g., carrier gas 130, 230, 330, and 430) passes through gas inlet 512 and is bubbled out of bubbler 514 upward through liquid coolant 520 (e.g., liquid coolant 120, 220, 320, and 420) in exchanger 502. Carrier gas 530 comprises a vapor component. This vapor component condenses, freezes, deposits, desublimates, or a combination thereof onto mesh screens 508 as a solid component. The solid component dissolves into liquid coolant 520, leaving mesh screen 508 clear of solids. Component-enriched liquid coolant 522 leaves through liquid outlets 510 while component-depleted carrier gas 538 leaves through gas outlet 504. As described previously, the mesh screen may result in diminished size bubbles 532, 534, 536.

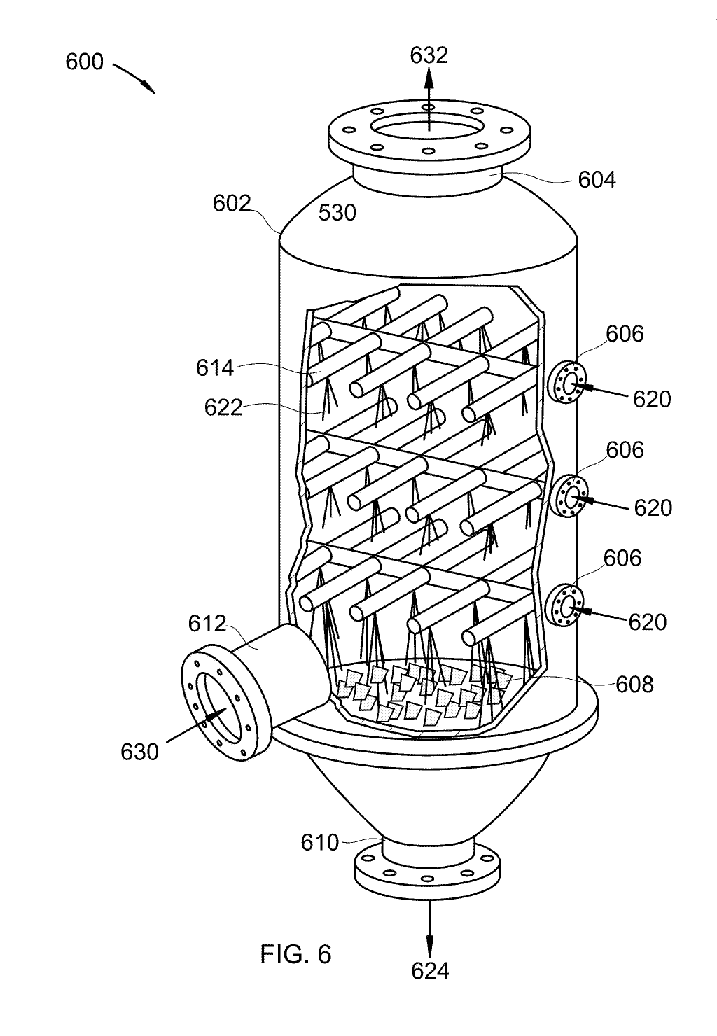

Referring now to FIG. 6, FIG. 6 shows an isometric cross-section 600 of a direct-contact exchanger 602 that may be used in the described devices, systems, and methods. Exchanger 602, a spray tower, consists of gas outlet 604, liquid inlets 606, packing material 608 (e.g. mesh screen 108, 208, 308, 408, and 508), liquid outlet 610, and gas inlet 612. Liquid inlets 106 end in spray nozzles 614. Carrier gas 630 (e.g., carrier gas 130, 230, 330, and 430) passes through gas inlet 612 and passes upward through descending spray 622. Liquid coolant 620 (e.g., liquid coolant 120, 220, 320, 420, and 520) enters through liquid inlets 606 and forms spray 622 through spray nozzles 614. Carrier gas 630 comprises a vapor component. This vapor component condenses, freezes, deposits, desublimates, or a combination thereof onto packing materials 608 as a solid component. The solid component dissolves into liquid coolant 624, leaving packing materials 608 clear of solids. Component-enriched liquid coolant 624 leaves through liquid outlet 610 while component-depleted carrier gas 632 leaves through gas outlet 604.

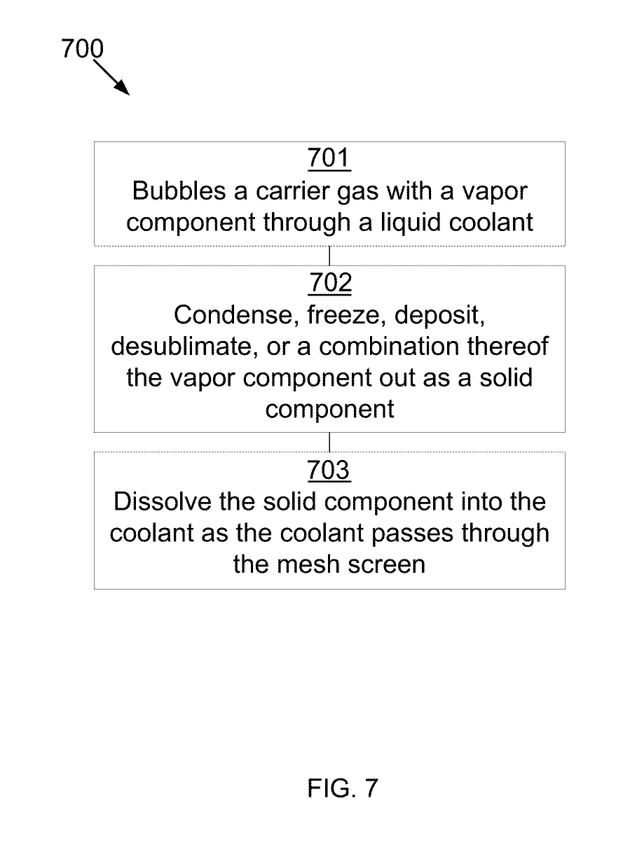

Referring now to FIG. 7, FIG. 7 shows a method 700 for stripping a vapor from a gas that may be used in the described devices, systems, and methods. A carrier gas bubbles through a liquid coolant in a vessel 701. The vessel consists of a mesh screen. In some embodiments, the vessel may contain a plurality of mesh screens. The carrier gas contains a vapor component. The vapor component condenses, freezes, deposits, desublimates, or a combination thereof out of the carrier gas onto the mesh screens as a solid component 702. The solid component dissolves into the coolant as the coolant passes through the mesh screens 703.

In some embodiments, the liquid coolant consists of water, hydrocarbons, liquid ammonia, liquid carbon dioxide, cryogenic liquids, or combinations thereof. In some embodiments, the hydrocarbons consist of 1,1,3-trimethylcyclopentane, 1,4-pentadiene, 1,5-hexadiene, 1-butene, 1-methyl-1-ethylcyclopentane, 1-pentene, 5,3,3,3-tetrafluoropropene, 5,3-dimethyl-1-butene, 5-chloro-1,1,1,2-tetrafluoroethane, 5-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

In some embodiments, the liquid coolant consists of a mixture of a solvent and either an ionic compound or a soluble organic compound. In some embodiments, the ionic compounds consist of potassium carbonate, potassium formate, potassium acetate, calcium magnesium acetate, magnesium chloride, sodium chloride, lithium chloride, and calcium chloride. In some embodiments, the soluble organic compounds consist of glycerol, ammonia, propylene glycol, ethylene glycol, ethanol, and methanol. In some embodiments, the solvent consists of water, hydrocarbons, liquid ammonia, liquid carbon dioxide, cryogenic liquids, or combinations thereof.

In some embodiments, the carrier gas consists of flue gas, syngas, producer gas, natural gas, steam reforming gas, hydrocarbons, light gases, refinery off-gases, organic solvents, steam, ammonia, or combinations thereof. In some embodiments, the vapor consists of carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

In some embodiments, the mesh screen or packing materials is made of stainless steel, carbon steel, galvanized steel, brass, aluminum, copper, ceramics, plastic polymers, or a combination thereof. In some embodiments, the mesh screen or packing materials may also have a coating comprising ceramics, polytetrafluoroethylene, polychlorotrifluoroethylene, natural diamond, man-made diamond, chemical-vapor deposition diamond, polycrystalline diamond, or combinations thereof. In some embodiments, the vessel is a direct-contact exchanger, such as a bubble contactor, a distillation column, a packed tower, an air-sparged hydrocyclone, or a nozzle-injected hydrocyclone. In some embodiments, the direct-contact exchanger contains a mist eliminator.

In some embodiments, passing the carrier gas involves bubbling the carrier gas through a bubble plate, a bubble tray, a sparger, or a combination thereof. In other embodiments, passing the carrier gas involves injecting the carrier gas into the vessel below a liquid inlet and passing the liquid coolant into the vessel through the liquid inlet, the inlet consisting of a nozzle, a sprayer, a drip tray, or a combination thereof. In other embodiments, passing the carrier gas involves a combination thereof.

In some embodiments, the mesh screens are vibrated such that the solid component breaks off of the mesh screen.

In some embodiments, large bubbles of the carrier gas break up into small bubbles as the large bubbles pass through the mesh screen.

In some embodiments, the liquid coolant contains an entrained solid. In some embodiments, the entrained solid consists of soot, dust, minerals, microbes, solid carbon dioxide, solid nitrogen oxide, solid sulfur dioxide, solid nitrogen dioxide, solid sulfur trioxide, solid hydrogen sulfide, solid hydrogen cyanide, ice, solid hydrocarbons, precipitated salts, or combinations thereof.

In some embodiments, the vessel contains an indirect-contact heat exchanger. In some embodiments, the indirect-contact heat exchanger further cools the liquid coolant. In some embodiments, the indirect-contact heat exchanger provides a surface on which the solid component forms and from which the solid component is dissolved into the liquid coolant. In some embodiments, the indirect-contact heat exchanger is vibrated such that the solid component breaks off of the indirect-contact heat exchanger.

1. A method for stripping a vapor from a gas comprising:
passing a carrier gas through a liquid coolant in a vessel, wherein the vessel comprises a mesh screen, packing material, or combinations thereof, and wherein the carrier gas comprises a vapor component;
condensing, freezing, depositing, desublimating, or a combination thereof, the vapor component out of the carrier gas onto the mesh screen, the packing material, or combinations thereof, as a solid component; and
dissolving the solid component into the coolant as the coolant passes through the mesh screen, the packing, or a combination thereof.

2. The method of claim 1, wherein the liquid coolant comprises water, hydrocarbons, liquid ammonia, liquid carbon dioxide, cryogenic liquids, or combinations thereof.

3. The method of claim 2, wherein the hydrocarbons comprise 1,1,3-trimethylcyclopentane, 1,4-pentadiene, 1,5-hexadiene, 1-butene, 1-methyl-1-ethyl cyclopentane, 1-pentene, 5,3,3,3-tetrafluoropropene, 5,3-dimethyl-1-butene, 5-chloro-1,1,1,2-tetrafluoroethane, 5-methylpentane, 3-methyl-1,4-pentadiene, 3-methyl-1-butene, 3-methyl-1-pentene, 3-methylpentane, 4-methyl-1-hexene, 4-methyl-1-pentene, 4-methyl cyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

4. The method of claim 1, wherein the liquid coolant comprises a mixture comprising a solvent and a compound from a group consisting of:
ionic compounds comprising potassium carbonate, potassium formate, potassium acetate, calcium magnesium acetate, magnesium chloride, sodium chloride, lithium chloride, and calcium chloride; and,
soluble organic compounds comprising glycerol, ammonia, propylene glycol, ethylene glycol, ethanol, and methanol.

5. The method of claim 4, wherein the solvent comprises water, hydrocarbons, liquid ammonia, liquid carbon dioxide, cryogenic liquids, or combinations thereof.

6. The method of claim 1, wherein the carrier gas comprises flue gas, syngas, producer gas, natural gas, steam reforming gas, hydrocarbons, light gases, refinery off-gases, organic solvents, steam, ammonia, or combinations thereof.

7. The method of claim 6, wherein the vapor comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

8. The method of claim 1, wherein the mesh screen, the packing material, or a combination thereof, comprise stainless steel, carbon steel, galvanized steel, brass, aluminum, copper, ceramics, plastic polymers, or a combination thereof.

9. The method of claim 8, wherein the mesh screen, the packing material, or a combination thereof, further comprise a coating comprising ceramics, polytetrafluoroethylene, polychlorotrifluoroethylene, natural diamond, man-made diamond, chemical-vapor deposition diamond, polycrystalline diamond, or combinations thereof.

10. The method of claim 1, wherein the vessel comprises a direct-contact exchanger comprising a bubble contactor, a distillation column, a packed tower, an air-sparged hydrocyclone, a nozzle-injected hydrocyclone, a spray tower, or a drip tower.

11. The method of claim 10, wherein an outlet of the gas from the direct-contact exchanger comprises a mist eliminator.

12. The method of claim 1, wherein passing the carrier gas comprises:
bubbling the carrier gas through a bubble plate, a bubble tray, a sparger, or a combination thereof;
injecting the carrier gas into the vessel below a liquid inlet and passing the liquid coolant into the vessel through the liquid inlet, the inlet comprising a nozzle, a sprayer, a drip tray, or a combination thereof; or
a combination thereof.

13. The method of claim 1, wherein a cooling fluid passes through an interior portion of the mesh screen.

14. The method of claim 1, further comprises large bubbles of the carrier gas breaking up into small bubbles as the large bubbles pass through the mesh screen.

15. The method of claim 1, wherein the liquid coolant includes an entrained solid.

16. The method of claim 15, wherein the entrained solid comprises soot, dust, minerals, microbes, solid carbon dioxide, solid nitrogen oxide, solid sulfur dioxide, solid nitrogen dioxide, solid sulfur trioxide, solid hydrogen sulfide, solid hydrogen cyanide, ice, solid hydrocarbons, precipitated salts, or combinations thereof.

17. The method of claim 1, wherein the vessel contains an indirect-contact heat exchanger.

18. The method of claim 17, wherein the indirect-contact heat exchanger further cools the liquid coolant.

19. The method of claim 18, wherein the indirect-contact heat exchanger provides a surface on which the solid component forms and from which the solid component is dissolved into the liquid coolant.

20. The method of claim 19, further comprising vibrating the indirect-contact heat exchanger such that the solid component breaks off of the indirect-contact heat exchanger.
